(19) United States
(12) Patent Application Publication
(10) Pub. No.: US 2005/0199535 A1
(43) Pub. Date: Sep. 15, 2005

(54) Dental waterline recirculator

(75) Inventor: Davis V. Yates, Lakeland, FL (US)

Correspondence Address: LARSON AND LARSON, 11199 69TH STREET NORTH, LARGO, FL, 33773, US

(73) Assignee: STONECREST INNOVATIONS, INC.

(21) Appl. No.: 10/797,988

(22) Filed: Mar. 11, 2004

(51) Int. Cl. B01D 33/82

(52) U.S. Cl. 210/104

(57) ABSTRACT

A device for recirculating water throughout a small bore tubing of a dental unit during non-use to prevent contamination from a biofilm buildup. The device includes a pump, a reservoir, and a decontaminator positioned along a waterloop formed by a plurality of water lines, the device for recirculating water also being under microprocessor control and connected to the dental unit.

### BACKGROUND OF THE INVENTION

1. Field of the Invention

The present invention relates to a dental unit waterline recirculator device. More particularly, it relates to a system that automatically recirculates chlorinated water through the small bore plastic tubing of the dental unit during periods of downtime such as overnight and holidays. This prevents stagnation of water in the tubing which is a major cause of bacterial growth and biofilm.

2. Description of the Prior Art

Most dental units operate in the same manner. Pressurized air controls the flow of water and air throughout the many handpieces and many feet of handpiece tubing. A foot pedal, operated by the dentist or technician, controls the flow of pressurized air. When not in use, the handpieces either rest in a saddle on the dental unit or, if they are detachable type handpieces, are removed for disinfection between patients. The saddles contain switches that are activated when a handpiece is resting in the saddle. Each saddle switch prevents water and air from flowing-to that particular handpiece when the foot pedal is depressed.

Contamination of dental unit waterlines from biofilm buildup is a growing concern in the dental profession. Biofilm is caused by water stagnating in the plastic tubing for long periods of time. The stagnating water allows bacteria, fungi, algae and protozoa to grow on the inside surface of the plastic tubing used in dental units. Scientific evidence suggests that the presence of significant amounts of bacteria in the tubing may pose a risk of exposing patients and dental personnel to contaminated aerosol. Reports have linked two post-operative Pseudomonas infections in patients with suppressed immune systems to exposure to contaminated aerosol. In addition, altered nasal flora and exposure to Legionella bacteria has been detected in dental personnel. The suspected cause of such exposure is inhalation of the fine water mist expressed by dental handpieces. Recognizing this potential health risk, the Occupational Health and Safety Administration (OSHA) has issued warnings about exposure to pathogens from dental waterline unit contamination.

The levels of colony-forming units (CFU) in dental unit waterlines have been known to exceed 1,000,000 CFU/ml. CFU are the minimum number of separable cells that can give rise to a visible colony. The Centers for Disease Control (CDC) and the American Dental Association (ADA) have published guidelines recommending that no more than 500 CFU/ml be present in the dental waterline. Because of the great difficulty and expense in maintaining this standard, this maximum has not yet been made mandatory.

Most current dental units employ a closed bottle system to provide a clean water supply. These devices utilize a flush and purge mechanism using disinfectants or germicides, however, the drawback to this method is the possibility that the chemicals will not be completely removed from the waterline and will be expelled into a patient's mouth, therefore, it is still recommended that the handpiece be flushed for 20 seconds prior to performing a procedure in a patient's mouth. If these procedures are improperly performed, bacterial buildup can be worse than if not performed at all. Furthermore, it has been reported that mature biofilms may become resistant to these treatments. In addition to being time consuming to operate, these devices can be very costly.

U.S. Pat. No. 5,044,952 describes a device designed to prevent stagnation in the water supply. This device utilizes a steady bleed of water through the dental waterline to a main waste outlet during periods of downtime. This is inefficient and presents the risk of a leak occurring. Additionally, the water in the line is heated slightly which has been found to increase biofilm buildup. U.S. Pat. No. 5,526,841 describes a device employing a manual flush and purge method of disinfecting. The waterline is flushed with a disinfectant solution and then purged using pressurized air. Since this process is not automatic, errors could result in germicide being expressed into a patient's mouth or bacterial buildup greater than if no disinfectant were used at all. U.S. Pat. No. 5,785,523 also describes a purge and flush system for disinfection of the dental unit tubing. This system is not automatic and the same dangers are present as with all flush and purge methods. U.S. Pat. No. 6,106,771 describes a method to descale and disinfect dental unit waterlines. This method is not automatic and it employs the use of descaling agents and antimicrobial agents retaining the risk that some of this disinfecting agents will be retained in the waterline. Furthermore, this system does not provide a simple means for preventing biofilm buildup in the individual handpiece lines.

Other devices are known to prevent contamination in other fields. U.S. Pat. No. 5,032,292 describes a method for preventing biofilm buildup in spas. This method employs a bidirectional flow directing water in one way when the jet pump is on and in another way when the circulation pump is on. This method could not be applied to a dental device and its handpiece lines. U.S. Pat. No. 5,178,830 describes a method for cleaning and sterilizing hemodialysis lines. This method could not be applied to dental units as it would be cost prohibitive due a greater necessity for total sterilization. In addition this device is not designed to function automatically.

There is a great need for an inexpensive device that is controlled automatically and that employs a safe and efficient method of preventing biofilm buildup.

### SUMMARY OF THE INVENTION

I have invented a dental waterline recirculator connected to a dental unit that operates automatically. The recirculator turns on at the end of each day when the air and water lines are turned off. Water is pumped out of a reservoir through a decontaminator and then through a small bore tubing of the dental unit. The decontaminator can be a chlorinator that maintains a level of chlorine equal to or just slightly above the level of municipal potable water, or it can employ other agents. The water recirculates approximately 15 minutes every hour, or one hour every four hours. When the work day begins, the air and water lines are turned back on and the reservoir drains and refills itself. High and low water sensors facilitate the automatic draining and refilling.

### BRIEF DESCRIPTION OF THE DRAWINGS

The invention may be best understood by those having ordinary skill in the art by reference to the following detailed description when considered in conjunction with the accompanying drawings in which:

FIG. 1 is a flow diagram of an initialization process of a preferred embodiment of the waterline recirculator of the present invention prior to daytime use;

FIG. 2 is a diagram of the preferred embodiment of the waterline recirculator connected to a dental unit during daytime use;

FIG. 3 is a flow diagram of an initialization process of the preferred embodiment of the waterline recirculator prior to nighttime recirculation;

FIG. 4 is a diagram of the preferred embodiment of the waterline recirculator connected to a dental unit during nighttime recirculation;

FIG. 5 is a flow diagram of an initialization process prior to daytime use of a first alternate embodiment of the waterline recirculator;

FIG. 6 is a diagram of the first alternate embodiment of the waterline recirculator connected to a dental unit and during daytime use;

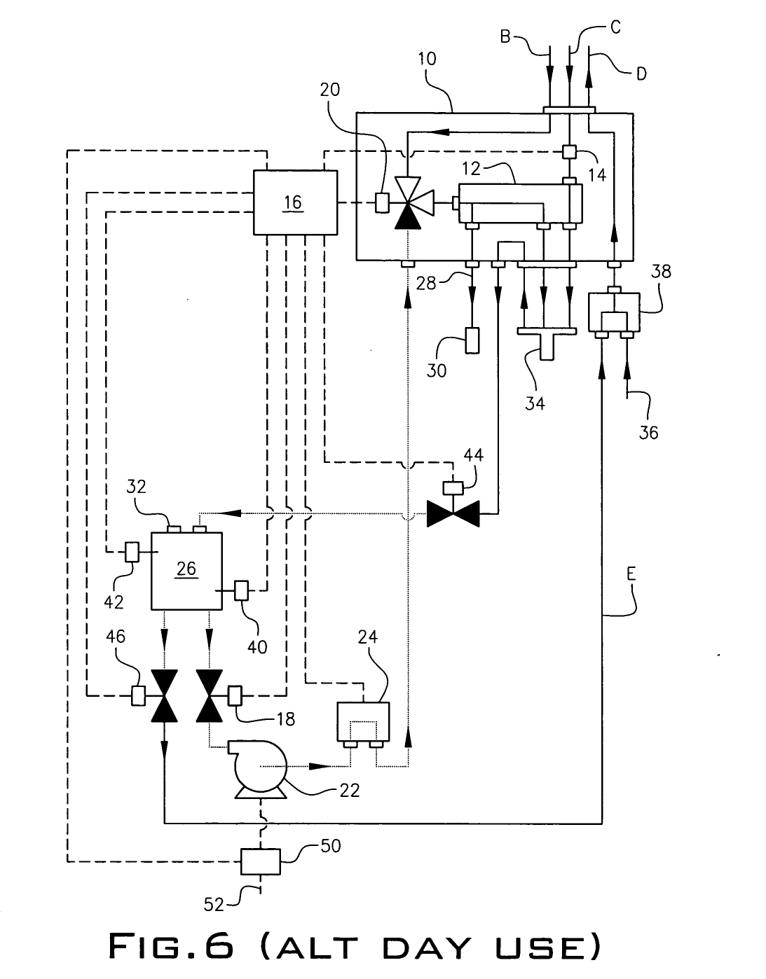

FIG. 7 is a diagram of the first alternate embodiment of the waterline recirculator connected to a dental unit during nighttime recirculation; and

FIG. 8 is a diagram of a third alternate embodiment of the waterline recirculator during daytime use.

### DETAILED DESCRIPTION OF THE INVENTION

Throughout the following detailed description, the same reference numerals refer to the same elements in all figures.

A dental unit waterline recirculator of the present invention works in three cycles: 1) Initialization 2) Day Use and 3) Nighttime Recirculation. Initialization will be discussed first, followed then by Day Use and then finally Nighttime Recirculation.

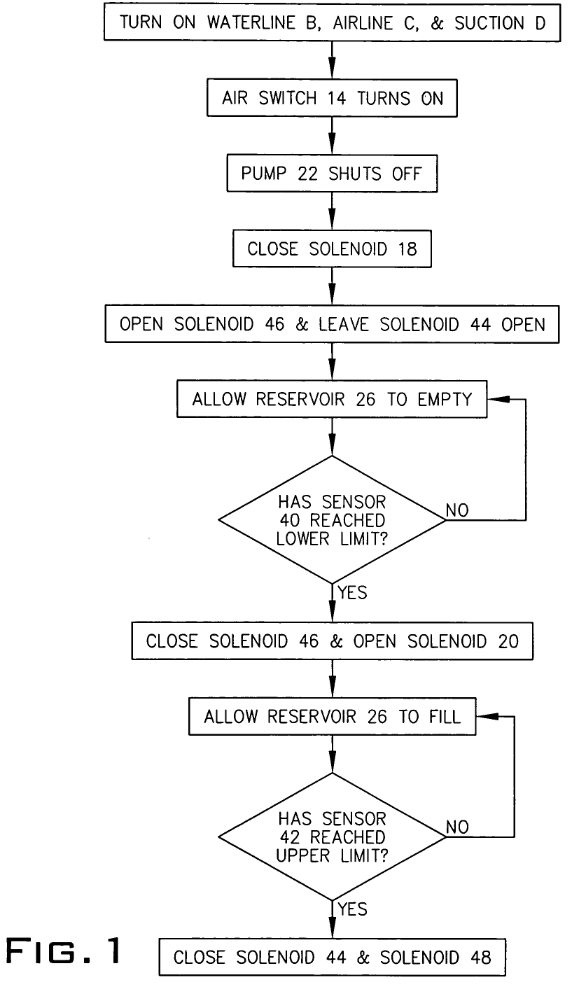

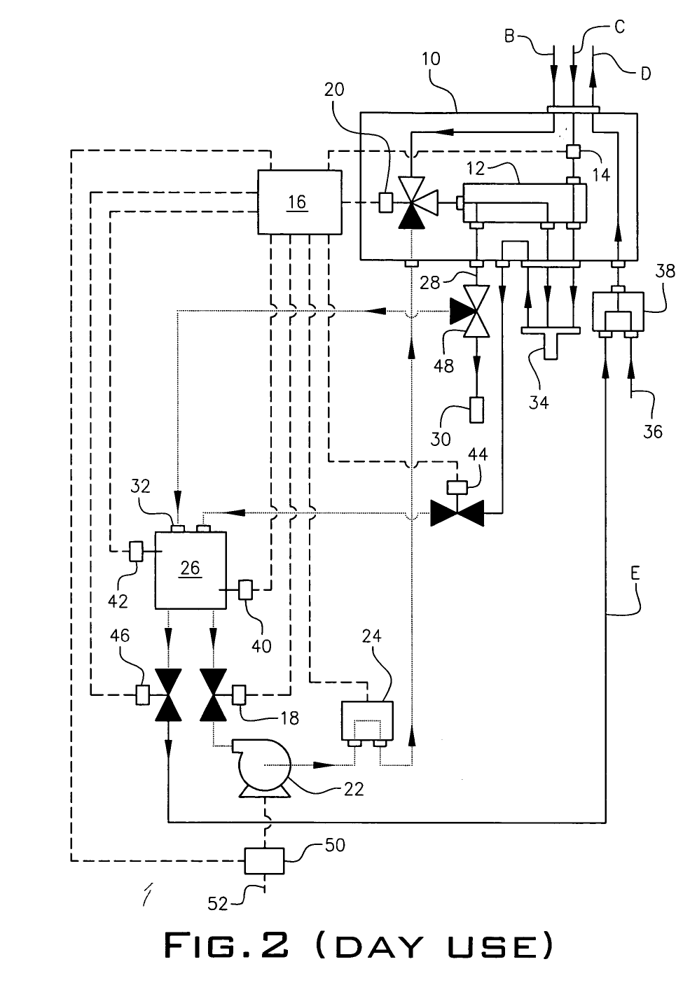

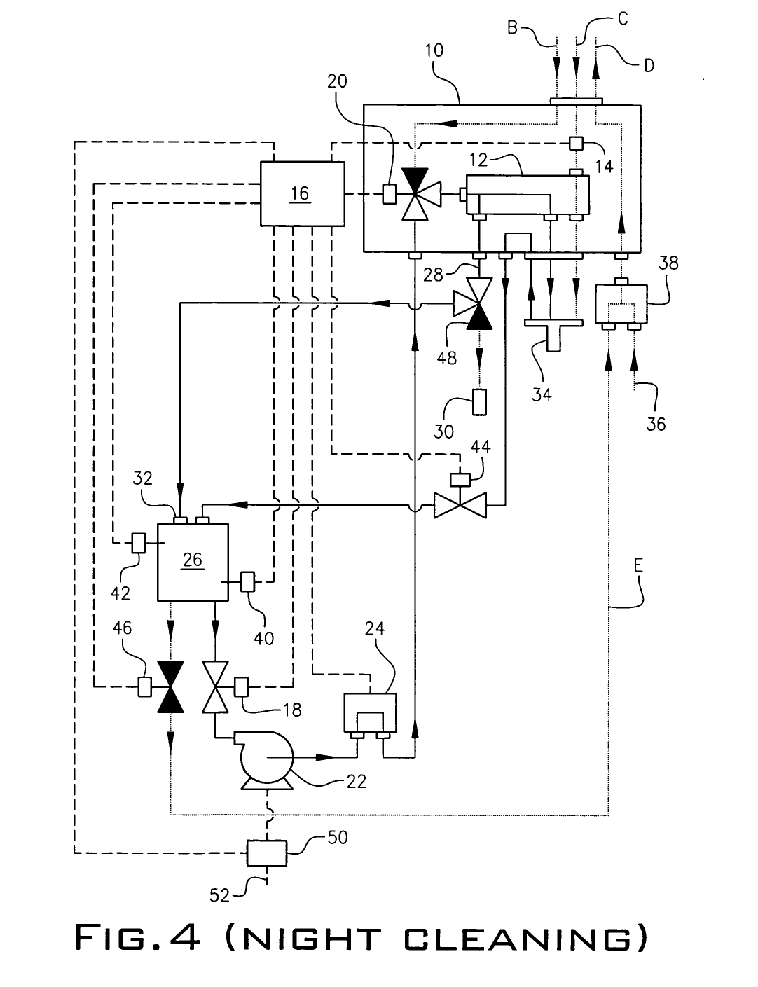

Initialization takes place at the beginning of the workday. Referring to FIGS. 1 and 2, in a preferred embodiment, dental healthcare worker first turns on a waterline B, a suction line D, and an air line C. When air line C is turned on, an air switch 14 inside a dental unit 10 turns on. Alerted by the activation of air switch 14, a microprocessor 16, coupled to air switch 14, directs a pump 22 to turn off, which had previously been activated from a nighttime procedure there before. Microprocessor 16 closes a solenoid valve 18 and opens a solenoid valve 46. A solenoid valve 44 remains open. As seen in FIG. 2, solenoid valve 46 is positioned intermediate a drain waterline between a water reservoir 26 and a suction canister 38 of this invention. A suction line E drains water reservoir 26 through suction canister 38 and finally through outgoing suction line D and to a waste receptacle (not shown). A low water sensor 40 located inside water reservoir 26 is coupled to microprocessor 16 by way of a unidirectional electrical connection. When the water level reaches the level of low water sensor 40, microprocessor 16 is alerted. At this time, solenoid valve 46 is closed. A three-way solenoid valve 20 was, prior to this point, closed to waterline B and open to a dental block 12 and a decontaminator 24 as shown in FIG. 4. Three-way solenoid valve 20 now opens to waterline B and dental block 12 and closes to decontaminator 24 as shown in FIG. 2. Water flows through dental unit 10 tubing and refills water reservoir 26 by way of solenoid valve 44 and a three-way solenoid valve 48 which, at this point, is open to dental unit 10 and water reservoir 26 as shown in FIG. 4. A high water level sensor 42 is coupled between water reservoir 26 and microprocessor 16 by way of a unidirectional electrical connection. When the water in water reservoir 26 reaches the high level mark, high water level sensor 42 alerts microprocessor 16. At this time, solenoid valve 44 connected to an non-detachable air water syringe 34 closes. Three-way solenoid valve 48 is positioned on a waterline between dental block 12, a detachable handpiece 30, and water reservoir 26 in a “T” formation. There can be a plurality of detachable type handpieces 30.

Prior to initialization, three-way solenoid valve 48 is open to dental block 12 and water reservoir 26 (see FIG. 4). Upon closing of solenoid valve 44, three-way solenoid valve 48 closes to water reservoir 26 and opens to detachable handpiece 30. The dental unit waterline recirculator is now in position for daytime use as shown in FIG. 2.

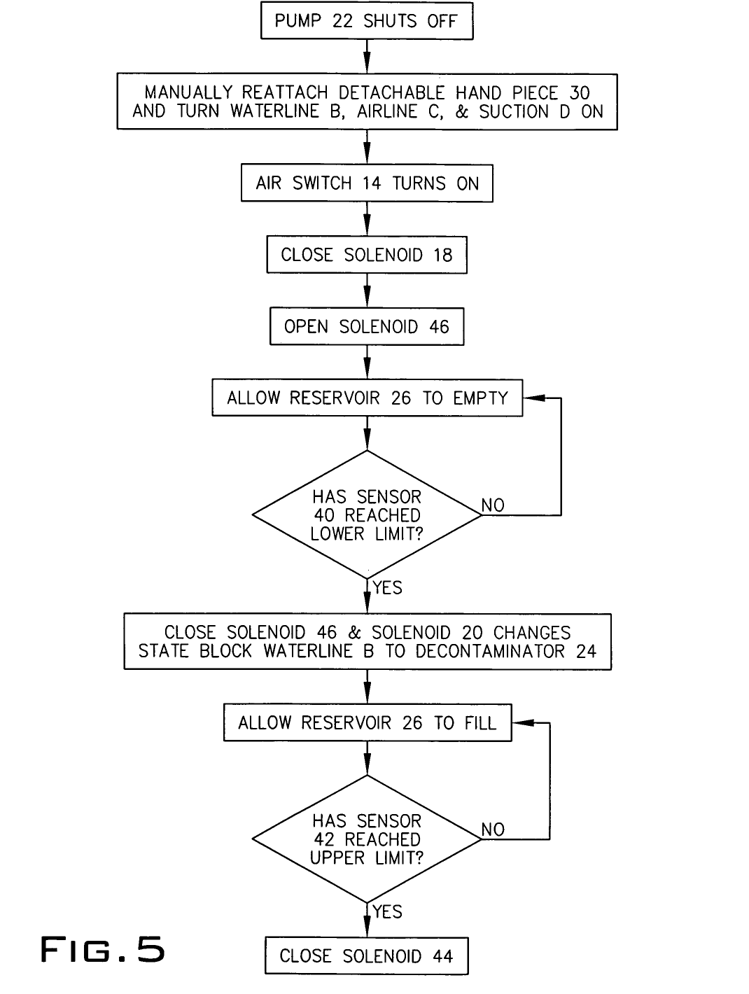

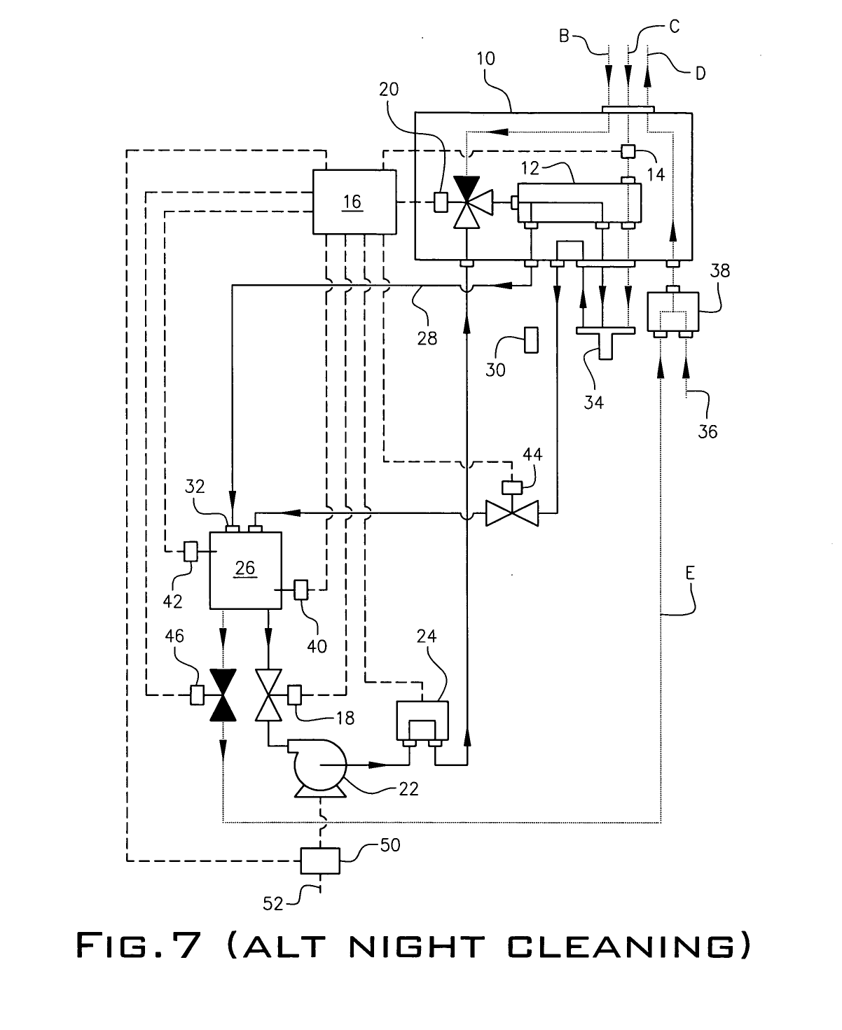

In a first alternate embodiment, initialization proceeds as shown in FIG. 5. In this first alternate embodiment, for nighttime recirculation, detachable handpiece 30 and detachable handpiece tubing 28 is inserted into an inlet 32 in water reservoir 26 as shown in FIG. 7. There are an equal number of inlets 32 as there are detachable handpieces 30. Initialization begins when microprocessor 16 turns pump 22 off at a preprogrammed user definable time. A dental technician removes detachable handpiece tubing 28 from inlet 32. Detachable handpiece 30 is reattached to its tubing 28 and returned to its holder, called a saddle, on dental unit 10. At this time, water line B, air line C and suction line D are turned on, thereby activating air switch 14. Activation of air switch 14 alerts microprocessor 16 whereby the initialization process of this first alternate embodiment follows the same steps from this point forward as outlined previously in FIG. 1. The final step however differs wherein only solenoid 44 closes at the termination of the process because solenoid 48 is not a component of this embodiment.

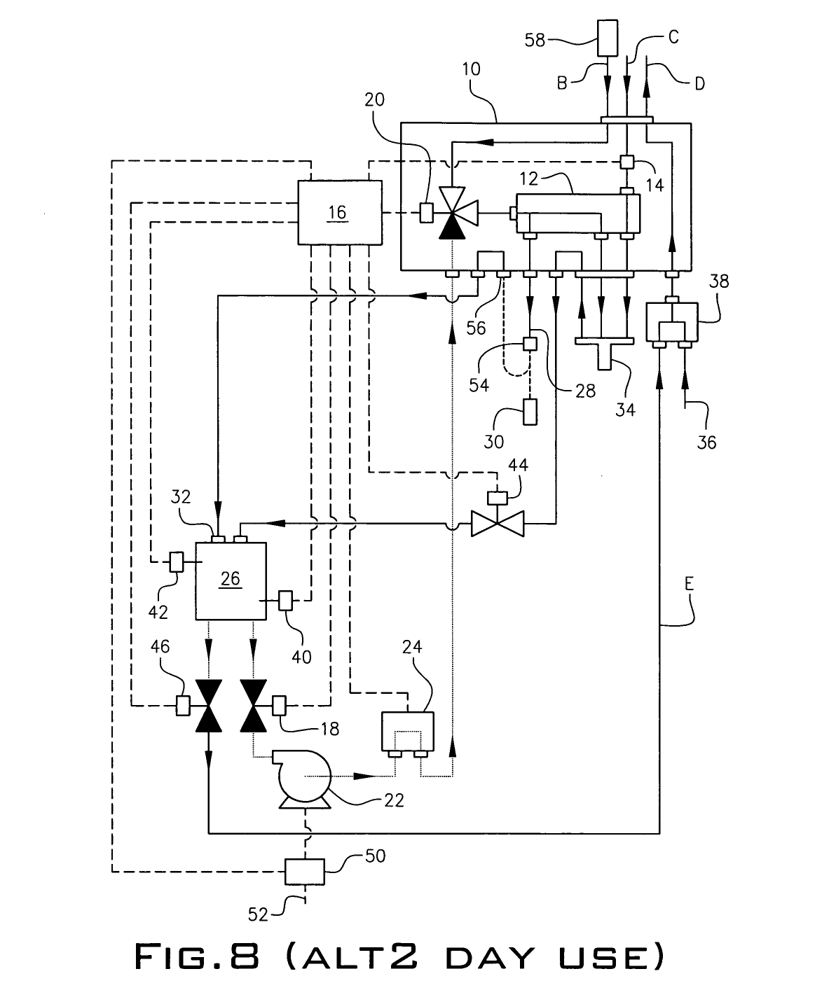

In a second alternate embodiment of the present invention, as shown in FIG. 8, prior to nighttime recirculation, handpiece 30 is removably attached to its tubing 28 by a quick release mechanism (not shown). Handpiece 30 is removed and an end 54 of tubing 28 is inserted into a handpiece insert 56, also having a quick release mechanism, located on dental unit 10. There are as many handpiece inserts 56 as there are detachable handpieces 30. The handpiece insert 56 connects to a waterline leading to the water reservoir 26. In those units with multiple handpieces 30 (not shown) each waterline from the respective handpiece insert 56 would feed into a single line that would be attached to the reservoir 26. In this second alternate embodiment, initialization would take place in the same manner as outlined previously in FIG. 1, although because solenoid 48 (shown in FIG. 2) is not a component of this embodiment, the initialization process is complete upon the closing of solenoid 44 which is a result of the water reservoir 26 reaching its upper limit.

Referring to FIG. 2, during daytime use, dental unit 10 contains dental block 12 and three-way solenoid valve 20. Waterline B carries water from a municipal water supply or a closed bottle system, whichever is used in the office, into dental unit 10 and into three-way solenoid valve 20. Three-way solenoid valve 20 diverts water from waterline B into dental block 12 which is a common component to all dental units functioning as a water and air router. Air line C delivers air from an air source, such as an air compressor or other source (neither shown), into dental unit 10 and directly into dental block 12. Air switch 14 is connected to microprocessor 16 which controls the air flow. During daytime use, air switch 14 is in the “ON” position allowing air to be carried from the air source to dental which routes water to detachable dental handpiece 30 and air and water to a non-detachable air water syringe 34. There can be a plurality of detachable handpieces 30 and non-detachable handpieces 34 connected to dental block 12. Suction canister 38 is attached to dental unit 10. Outgoing suction line D leaves suction cannister 38, is directed through dental unit 10, and empties into a waste receptacle (not shown). Dental suction tool 36 is connected to suction cannister 38. Suction line E is connected to solenoid valve 46 which is closed for daytime use thereby prohibiting any water drain from reservoir 26.

Referring to FIG. 8, daytime use of this alternate embodiment varies only slightly. The quick release mechanism and handpiece insert 56 on dental unit 10 can be used during daytime operation as procedures are being performed. When detachable handpieces 30 are removed between patients for cleaning, quick release end 54 of handpiece tubing 28 can be inserted into handpiece insert 56. This prevents exposure of a free end of tubing 28 to particulate and aerosol in the air. In those dental units equipped with the handpiece inserts 56, the insert 56 would contain a switch (not shown) that is activated when the quick release end 56 inserts therein. The switch works in the same manner as the saddle switch and would prevent water and air from entering the tubing 28 when not in use. In this second alternate embodiment, the water line B is shown connected to a closed bottle 58.

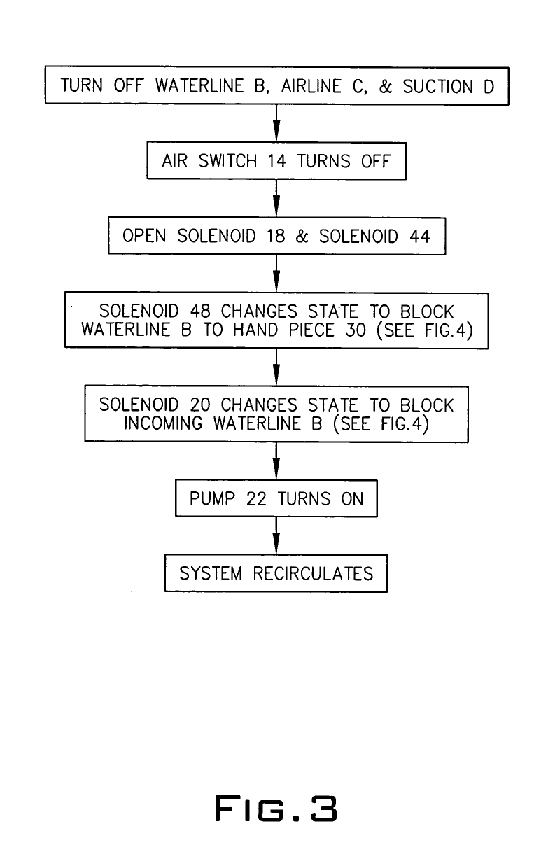

As to nighttime recirculation, and referring to FIGS. 3 and 4, waterline B, air line C, and suction line D are all shut off. Air switch 14 detects that air line C is off and alerts microprocessor 16. Microprocessor 16 opens solenoid valve 18 and solenoid valve 44. Solenoid valve 48 changes state so as to block the water line coupled to the detachable handpiece 30 and open the water line coupled to water reservoir 26 and dental block 12. Three-way solenoid valve 20 changes state so as to block waterline B and open to dental block 12 and decontaminator 24. Thereafter, pump 22 turns on. As shown in FIG. 4, water from the reservoir 26 flows through solenoid valve 18, through pump 22 and into decontaminator 24. In the preferred embodiment, decontaminator 24 contains a sensor (not shown) coupled electrically to the microprocessor 16 that detects the level of decontaminant present in the recirculating water. Once the decontaminant sensor detects that decontaminant has fallen below a user defined threshold level, microprocessor 16 signals a dental personnel by an audio or visual alarm that more decontaminant must be added to the decontaminator 24. Alternatively, the decontaminant can be automatically injected by decontaminator unit 24. In yet another embodiment, decontaminator 24 can be an entirely passive unit, wherein it is periodically refilled by a dental personnel with decontaminant tablets or liquid.

With continuing reference to FIGS. 3 and 4, water flows out of decontaminator 24 into dental unit 10 and into solenoid valve 20. Solenoid valve 20 directs the water into dental block 12 wherein it is diverted into each detachable dental handpiece tube 28 and into each non-detachable dental handpiece 34. The water then flows through detachable handpiece tubing 28 into three-way solenoid valve 48 and back into the water reservoir 26 where it can be recirculated.

In the first alternate embodiment of FIG. 7, prior to turning off waterline B, airline C and suction line D, a dental worker manually detaches removable handpiece 30 from its respective tubing 28, exposing a free end which inserts into an inlet 32 on top of water reservoir 26. Waterline B, airline C and suction line D are then shut off. The nighttime initialization then occurs as presented in FIG. 3 except in this first embodiment, solenoid valve 48 is not employed. During recirculation, water flows from dental block 12, into detachable handpiece tubing 28 and directly into water reservoir 26 by way of inlet 32 on the water. Additionally, water flows through non-detachable air water syringe 34, through solenoid valve 44 and back into dental unit 10 where it can be recirculated according to user defined parameters. The water flows into and out of non-detachable air water syringe 34 by way of specially manufactured tubing containing an incoming and outgoing waterline, in addition to the air line.

In the second alternate embodiment of FIG. 8, recirculation occurs as illustrated in the diagram in FIG. 3, except that solenoid 48 is not a component of this second alternate embodiment. Prior to air, water and suction shut off, handpiece 30 is removed and the quick release end 54 of tubing 28 is inserted into handpiece insert on the dental unit 10. The water flows through detachable handpiece tubing 28 back into dental unit 10 by way of the handpiece insert 56 and then into the waterline connected to reservoir 26. Upon the water flow reaching reservoir 26 a complete loop is made and the water can be recirculated. In the preferred embodiment, the system would Recirculates the water for about 15 minutes every one hour, or alternatively, for one hour every four hours. In alternate embodiments, the user can set the recirculation parameters as desired.

It is understood that while solenoid valves are preferred and referenced in the detailed description above, nothing herein limits these valves to only solenoid type valves.

Equivalent elements can be substituted for the ones set forth above such that they perform the same function in the same way for achieving the same result.

1. An automatic waterline recirculator device for use on a dental unit, the dental unit containing a dental block for diverting air and water to a plurality of handpieces, an air switch, and an air, water, and suction line; the automatic waterline recirculator device comprising:
a) a water reservoir having water level sensors;
b) a pump;
c) a decontaminator unit;
d) a plurality of waterlines forming a water loop;
e) a plurality of valves located along the waterloop; and
f) a microprocessor coupled to the sensors, the air switch, the plurality of valves and the pump.

2. The automatic waterline recirculator device of claim 1, wherein the air switch automatically activates the microprocessor.

3. The automatic waterline recirculator device of claim 1, wherein a first valve is positioned on the waterloop between the water reservoir and a pump; and a second valve is positioned on a drain line between the water reservoir and a suction line.

4. The automatic waterline recirculator device of claim 1, wherein the decontaminator unit is positioned on the waterloop between the dental unit and the pump.

5. The automatic waterline recirculator device of claim 1, further comprising a first three-way valve located inside the dental unit and positioned on the waterloop between the dental block, the decontaminator, and an outside waterline; and a second three-way valve positioned on the waterloop between a detachable handpiece line, the dental block and the water reservoir.

6. The automatic waterline recirculator device of claim 1, further comprising a non-detachable handpiece having a tube containing an air line, an incoming waterline and an outgoing waterline; the outgoing waterline connected to a third valve.

7. The automatic waterline recirculator device of claim 6, wherein the third valve connects the outgoing waterline of the non-detachable handpiece to the water reservoir.

8. The automatic waterline recirculator device of claim 1, wherein the water reservoir contains a number of inlets equal to a number of handpieces, each of the number of handpeices being detachable.

9. The automatic waterline recirculator device of claim 8, wherein each detachable handpiece detaches from a detachable handpiece tubing and a free end inserts into an inlet located on the top surface of the water reservoir.

10. The automatic waterline recirculator device of claim 1, wherein water flows through the waterloop from the water reservoir through the decontaminator and into the dental unit where it is diverted into the dental block, through all of the handpiece lines, and back to the water reservoir.

11. The automatic waterline recirculator device of claim 1, wherein the decontaminator unit has a sensor that detects the level of decontaminant present in the water recirculating therethrough.

12. The automatic waterline recirculator device of claim 1, wherein the decontaminator is a chlorinator.

13. The automatic waterline recirculator device of claim 1, wherein the dental unit contains a number of handpieces equaling a number of detachable handpiece line inserts, the number of handpeices being detachable.

14. The automatic waterline recirculator device of claim 13, wherein each detachable handpiece insert line connects to a separate waterline leading to the water reservoir.

15. An automatic waterline recirculator device for use on a dental unit, the dental unit containing a dental block for diverting air and water to a plurality of handpieces and an air switch; the waterline recirculator device comprising:
a) a water reservoir having a high water level sensor and a low water level sensor;
b) a pump;
c) a decontaminator unit;
d) a plurality of waterlines forming a waterloop;
e) a plurality of valves located along the waterloop;
f) a microprocessor coupled to the sensors, the air switch, the plurality of valves and the pump;
g) a three-way valve located inside the dental block positioned between the decontaminator, a dental block, and an outside waterline.; and
h) a power source providing electrical current to the waterline recirculator device.

16. The automatic waterline recirculator device of claim 15, wherein a first valve is located on the waterloop between the water reservoir and the pump; and a second valve is located on a drain line between the water reservoir and a suction line.

17. The automatic waterline recirculator device of claim 15, further comprising a non-detachable handpiece having an air line and an incoming and outgoing waterline; the outgoing waterline connecting to the water reservoir and having a third valve located there between.

18. The automatic waterline recirculator device of claim 15, wherein a number of detachable handpieces is equal to a number of handpiece line inserts on the dental unit; each handpiece line inserts connected to a waterline leading to the reservoir.

19. The automatic waterline recirculator device of claim 15, wherein the water reservoir has a number of inlets equal to a number of handpieces, wherein the number of handpieces detach and a free end of each detachable handpiece has a piece of tubing for inserting into its own inlet.

20. The automatic waterline recirculator device of claim 15, wherein water flows from the water reservoir, through the decontaminator, into the dental unit and block, through a et of the detachable and non-detachable handpiece tubing pieces and back into the water reservoir along the waterloop.
